(19) United States
(12) Patent Application Publication
(10) Pub. No.: US 2021/0267316 A1
(43) Pub. Date: Sep. 2, 2021

(54) METHOD FOR PROCUCING A SHOE, IN PARTICULAR A SPORTS SHOE

(71) Applicant: PUMA SE, Herzogenaurach (DE)

(72) Inventors: Matthias HARTMANN, Forchheim (DE); Reinhold SUSSMANN, Scheinfeld (DE)

(21) Appl. No.: 15/999,795

(22) PCT Filed: Feb. 19, 2016
(86) PCT No.: PCT/EP2016/000297

§ 371 Date: May 13, 2021

(51) Int. Cl. A43D 1/02; A43B 13/04; A43B 13/32; A43B 13/18; B29D 35/12; A43D 1/08

(52) U.S. Cl. CPC A43D 1/025; A43B 13/04; A43B 13/32; A43D 1/022; B29D 35/122; A43D 1/08; A43B 13/188

(57) ABSTRACT

A method for producing a shoe, in particular a sports shoe. In order to provide an optimally fitting shoe in a simple manner, the method comprises the following steps according to the invention: a) Measuring at least one individual characteristic of the foot of a person and/or one walking characteristic of the person by means of a measuring device; b) Determining the progression of a material characteristic and/or mechanical characteristic of at least one sole or one sole part of the shoe along at least one direction of extend of the sole or of the sole part in accordance with the values measured according to step a) using a specified algorithm or a specified rule; c) Producing the sole or a sole part of the shoe, wherein the material characteristics and/or mechanical characteristics are varied along the at least one direction of extend of the sole or of the sole part such that the material characteristic and/or mechanical characteristics at least approximately correspond to the progression determined according to step b); d) Connecting the sole produced according to step c) or the sole part to an upper in order to complete the shoe.

The invention relates to a method for producing a shoe, in particular a sports shoe.

Classical production methods for shoes, especially for sports shoes, are known. Mostly a shoe sole—as the case may be consisting of several parts (outer sole, midsole, inner sole)—is produced which often occurs by injection moulding of a suitable plastic material. Then, the shoe upper is produced, wherein leather of textile materials can be employed. For finishing of the shoe the sole and the shoe upper are connected with another, for example by sewing or gluing.

Thereby, in the given case also individual requirements of the user of the shoe can be considered, wherein customisation can take place. However, this requires normally a high expenditure because work of respective shoe specialists is required in significant amount.

It is the object of the invention to further develop a method of the kind mentioned above in such a manner that it becomes possible to provide an optimal fitting shoe in a simple and cost efficient manner. Thereby, the shoe should be producible quickly and thus cost-efficiently, however it should satisfy individual requirements of the user. The work of specialists at the shoe production should be reduced or totally avoided.

The solution of this object of the invention is characterized in that the method for the production of the shoe comprises the steps:

a) Measuring at least one individual characteristic of the foot of a person and/or one walking characteristic of the person by means of a measuring device;

b) Determining the progression of a material characteristic and/or mechanical characteristic of at least one sole or one sole part of the shoe along at least one direction of extend of the sole or of the sole part in accordance with the values measured according to step a) using a specified algorithm or a specified rule;

c) Producing the sole or a sole part of the shoe, wherein the material characteristics and/or mechanical characteristics are varied along the at least one direction of extend of the sole or of the sole part such that the material characteristic and/or mechanical characteristics at least approximately correspond to the progression determined according to step b);

d) Connecting the sole produced according to step c) or the sole part to an upper in order to complete the shoe.

The measuring according to above step a) takes place preferably by determining the pressure distribution of the foot of the person along the contact area of the foot on the ground; the measuring takes place in this case preferably by means of a pressure sensor plate.

The measuring according to above step a) takes place according to another preferred solution by determining the running behaviour of the person, especially the tendency of the foot to pronation or to supination. The measuring takes place in this case preferably by means of a camera and a treadmill.

The determination according to above step b) takes place preferably by determining the progression of a material characteristic and/or mechanical characteristic along the longitudinal axis of the sole. However, it can also be provided beneficially that the progression of a material characteristic and/or mechanical characteristic along the axis which runs transversal to the longitudinal axis of the sole is determined. Specifically preferred is a combination of both mentioned approaches whereby said progression of a material characteristic and/or mechanical characteristic takes place along the plane at which the foot of the wearer contacts the ground.

The production according to above step c) takes place preferably by adding at least one additive in sections in different quantities to a base material of the sole or of the sole part at the production of the sole or the sole part.

Thereby, a special embodiment provides that the base material of the sole or the sole part is polyurethane. Then, by adding of an additive the material characteristic and/or mechanical characteristic of the polyurethane can be modified and thus controlled selectively. Thereby, it is well known in the state of the art which additives are suitable to especially influence for example the hardness of the polyurethane.

The material characteristic which is modified along at least one direction of extent of the sole or of the sole part is preferably the hardness of the material, especially the Shore hardness.

The produced sole part is preferably a midsole of the shoe and/or an outsole of the same.

The sole can be sewed and/or glued with the upper at connecting according to above step d).

The proposed method is preferably beneficial when it is carried out on an integrated facility, which allows a focussed production of the shoe temporally as well as areal. Accordingly, the above steps a) to d) can be take place in areal closeness, especially in a shoe store. The steps a) to d) can also take place in temporal closeness, especially within a period of maximal 3 hours. Thereby it is possible to offer a shoe to a customer very quickly which shoe is tailored to his individual needs which fits optimal to his circumstances.

Thus, the proposed concept is basing on the idea to produce a sole and a part of the same respectively (midsole and/or outer sole) according to the demands beneficially directly in a shoe shop, wherein the sole and the sole part respectively comprises different properties in sections and in predetermined zones respectively.

In general, sole producing machines which allow such a production are known in the state of the art. Exemplarily, reference is made to sole machines of Klöckner Desma Schuhmaschinen GmbH which allow to produce a sole and a sole part respectively not only homogeneous of one single material but to control the injection moulding process of the sole and the sole part respectively in such a manner that an non-homogeneous structure is obtained.

Preferably at the proposed idea—as mentioned—a polyurethane mixture is varied in its properties by adding at least one suitable additive which is presently used according to the invention to provide a shoe sole in sections with different properties.

At the location of the facility, especially thus in a shoe shop, then at first for example a scan of the foot of the customer is produced and determined which running characteristics the customer has. Dependent from that the design of the sole is determined with respect to different zones and those then produced locally and connected with a shoe upper.

Beneficially so an individual custom-fit shoe, which thus is individually adapted to the customer, can be produced quickly and thus in a cost efficient manner.

In the drawing an embodiment of the invention is shown.

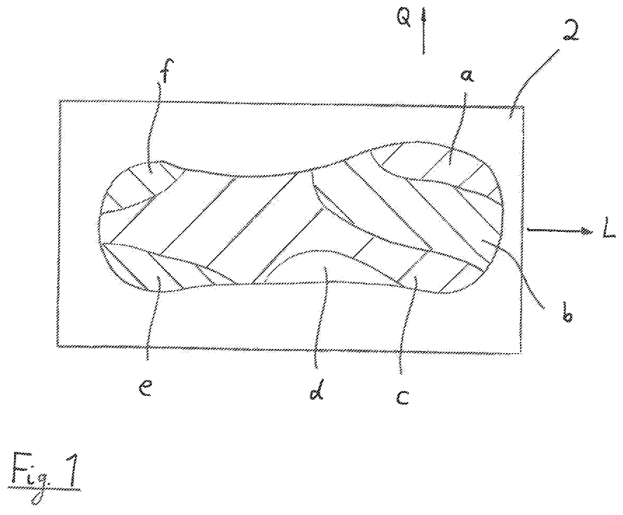

FIG. 1 shows schematically the top plan view of a pressure sensor plate by which the pressure distribution of a foot of a person was recorded along the contact area on the ground,

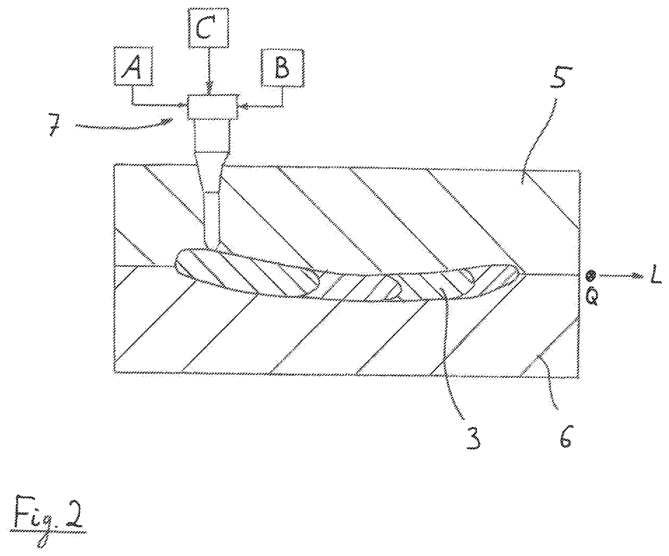

FIG. 2 shows schematically an injection moulding tool in a sectional side view by which the sole of a shoe is produced and

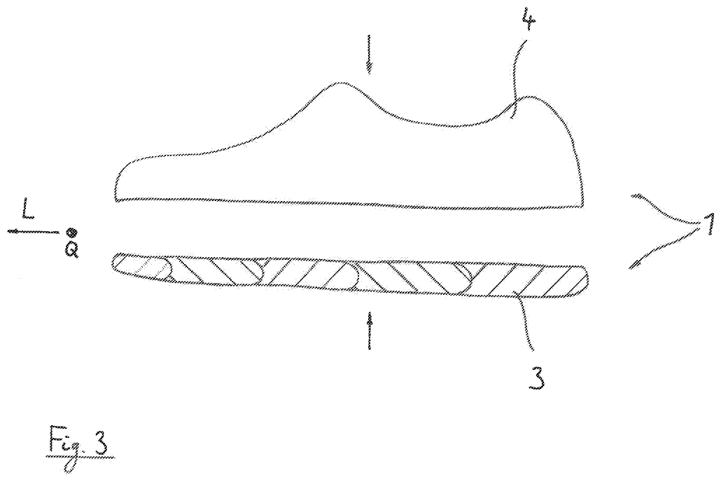

FIG. 3 shows the finish sole and a shoe upper before joining of both parts.

In FIG. 1 a plane pressure sensor plate 2 is schematically shown which functions as measuring device by which the pressure distribution is measured which results when a person steps on the pressure sensor plate 2. Schematically and only for the purpose of illustration six regions a, b, c, d, e and f are depicted in which a different pressure is given when the person stands on the ground.

Insofar by means of the pressure sensor plate 2 can be determined how the pressure distribution for an individual person results due to the personal ergonomics of the foot. Thus, by means of the pressure sensor plate 2 it is possible to identify the mentioned regions a, b, c, d, e and f in which different pressures are given (wherein for the different mentioned regions respective pressure ranges can be defined). Due to the longitudinal axis L of the foot and correspondingly to the sole of the shoe which has to be produced as well as to the transverse oriented direction Q hereto thus the pressure distribution can be determined by means of the pressure sensor plate along the contact area of the foot on the ground for an individual person.

Said measurement of the pressure distribution along the contact area constitutes a first step at the production of an individual shoe (see above mentioned step a).

Alternative or additive said measurement can also be carried out in another manner: For example by means of a camera the foot of the person can be monitored during running or jogging on a treadmill and herefrom conclusions can be obtained concerning the pronation and supination behaviour of the foot of the person.

In both cases it is general possible in the further process according to above step b) to determine the progression of a material characteristic and mechanical characteristic respectively of the shoe sole which has to be produced. By that it has to be understood that for different regions of the sole in the direction of the longitudinal axis L of the sole as well as in the direction Q transverse hereto for example the rigidity or hardness of the material of the sole is defined which is aimed for to supply an optimal support to the foot of the person.

So, for example it can be provided that in the regions in which a high pressure is given in relation to other regions (see for example region a) in relation to the region d) in FIG. 1) a harder material is provided as it is the case in other regions of the sole to give insofar the foot a better support.

In the same manner for example a deviation from the ideal shape can be counteracted additively or alternatively by the evaluation of the pronation or supination behaviour of the foot of the person by selectively increase or reduce the rigidity of the material and accordingly the stiffness of the material of the sole.

This determination of the progression of the material property and accordingly the mechanical property of the sole along the coordinates L and Q can thereby be carried out by a specialist. But it is also possible that the determined values which are measured by the measuring device 2 are automatically converted in a respective specification for said properties by means of a preset algorithm. Accordingly, above step b) is preferably carried out automatically by a computer. For doing so as the case may be stored comparative values or optimal values can be taken in consideration for the determination of the progression of the properties, wherein said values as the case may be can also be taken from a database after providing the data of the person (for example size, weight, sex).

In FIG. 2 above mentioned step c) of the production of a sole 3 is depicted. An upper part of tool 5 and a bottom part of tool 6 of an injection moulding tool can be seen in which a cavity for the sole 3 is designed. Via a sprue system plastic material is injected into the cavity of the tool, wherein here a mixing head 7 is indicated in which polyurethane is produced and given into the tool. Thereby, a first base material A in the form of polyol is mixed with a second base material B in the form of isocyanate to obtain polyurethane.

Also depicted is furthermore a container for an additive C which can be added to the materials A and B and which changes its material properties and accordingly its mechanical properties.

As it is indicated in FIG. 2 by different shadings different sections of the sole 3 are designed by different choice of the components A, B and C and especially different addition amounts of the additive C along the extension direction L of the sole 3 which are characterized by different material characteristics and/or mechanical characteristics. Thereby the control of the addition of the components A, B, C into the mixing head 7 takes place in such a manner that the desired progression for the regions a, b, c, d, e and f is obtained as shown in FIG. 1.

Needless to mention at this point that FIG. 2 is insofar a schematic depiction of the described principle only, wherein it will be necessary at a respective predetermination of the material distribution in two coordinate directions L and Q (as shown in FIG. 1) as the case may be to prepare and to inject material by several injection nozzles and accordingly mixing heads 7 at different locations of the tool to selectively obtain a desired distribution of the material with the respective properties in the plane. The machine technology which is necessary for doing so is however known and needs not to be explained here in detail.

As the case may be the control of the addition of the components A, B, C can occur by a numerical rheological analysis of the flow behaviour of the material which is injected into the cavity (so-called “Meltflow” analysis) so that the desired layering of the materials with different properties after complete filling of the cavity is given in the cavity (see shadings of the sole 3 in FIG. 2).

Finally, in FIG. 3 the execution of above step d) is illustrated whereby the now finished produced sole 3 is connected with a shoe upper 4 to complete the shoe 1 (see the two arrows which are directed to another).

The connection between sole 3 and shoe upper 4 can take place in known manner, thus especially by sewing or gluing.

### LIST OF REFERENCES

1 Shoe
2 Measuring device (pressure sensor plate)
3 Sole
4 Upper
5 upper part of tool
6 bottom part of tool
7 Mixing head
L Direction of extend of the sole
   (longitudinal axis of the sole)
Q Direction transverse to the longitudinal axis
A First base material (polyol)
B Second base material (isocyanate)
C additive
a, b, c,
d, e, f Regions of different pressure

1-12. (canceled)

14-15. (canceled)

16. A method for producing a shoe, in particular a sports shoe, comprising the steps:
a) measuring at least one individual characteristic of the foot of a person and/or one walking characteristic of the person by means of a measuring device;
b) determining the progression of a material characteristic and/or mechanical characteristic of at least one sole or one sole part of the shoe along at least one direction of extend of the sole or of the sole part in accordance with the values measured according to step a) using a specified algorithm or a specified rule;
c) producing the sole or a sole part of the shoe, wherein the material characteristics and/or mechanical characteristics are varied along the at least one direction of extend of the sole or of the sole part such that the material characteristic and/or mechanical characteristics at least approximately correspond to the progression determined according to step b);
d) connecting the sole produced according to step c) or the sole part to an upper in order to complete the shoe, wherein
the production according to step c) takes place by injecting of plastic material into the cavity of an injection molding tool, wherein at least one additive is added in sections in different quantities to a base material of the sole or of the sole part at the production of the sole or the sole part.

17. The method according to claim 16, wherein the measuring according to step a) takes place by determining the pressure distribution of the foot of the person along the contact area of the foot on the ground.

18. The method according to claim 17, wherein the measuring takes place by means of a pressure sensor plate.

19. The method according to claim 16, wherein the measuring according to step a) takes place by determining the running behavior of the person, especially the tendency of the foot to pronation or to supination.

20. The method according to claim 19, wherein the measuring takes place by means of a camera and a treadmill.

21. The method according to claim 16, wherein the determination according to step b) takes place by determining the progression of a material characteristic and/or mechanical characteristic along the longitudinal axis of the sole.

22. The method according to claim 16, wherein the base material of the sole or the sole part is polyurethane.

23. The method according to claim 16, wherein the material characteristic which is modified along at least one direction of extend of the sole or of the sole part is the hardness, especially the Shore hardness.

24. The method according to claim 16, wherein the produced sole part is a midsole of the shoe.

25. The method according to claim 16, wherein the produced sole part is an outsole of the shoe.

26. The method according to claim 16, wherein the sole is sewed and/or glued with the upper at connecting according to step d).

27. The method according to claim 16, wherein the steps a) to d) take place in areal closeness, especially in a shoe store.

28. The method according to claim 16, wherein the steps a) to d) take place in temporal closeness, especially within a period of maximal 3 hours.
